(19) United States
(12) Patent Application Publication
(10) Pub. No.: US 2007/0060195 A1
(43) Pub. Date: Mar. 15, 2007

(54) Communication apparatus for playing sound signals

(76) Inventor: Yueh Wen Hsiang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/595,851

(22) Filed: Nov. 13, 2006

Related U.S. Application Data
(63) Continuation-in-part of application No. 10/784,244, filed on Feb. 24, 2004, now abandoned.

(51) Int. Cl. H04M 1/00

(52) U.S. Cl. 455/550.1

(57) ABSTRACT

A communication apparatus for playing sound signals includes a cellular phone and wireless earphones. The cellular phone primarily communicates with the wireless earphones via Bluetooth signals. The cellular phone has a first sound processing module for encoding, a music playing module for outputting music data, and a first Bluetooth module. The wireless earphones have a second sound processing module for decoding, an output unit for outputting music, and a second Bluetooth module. The music data from the music playing module can be encoded into digital data matching the Bluetooth protocol by using the first sound processing module. Next, the encoded music data is sent to the wireless earphones. After being received, the encoded music data is decoded via the second sound processing module and then outputted by the output unit. Thereby, the cellular phone can use Bluetooth signals to transmit the music data to the wireless earphones for playing.

### CROSS-REFERENCE TO RELATED APPLICATIONS

This Application is a Continuation-in-Part of application Ser. No. 10/784244, filed on 24 Feb. 2004, and entitled COMMUNICATION APPARATUS FOR PLAYING SOUND SIGNALS.

### FIELD OF THE INVENTION

The present invention is directed to a communication apparatus for playing sound signals, and more particularly, to a communication apparatus constituting of a Bluetooth cellular phone and wireless earphones.

### BACKGROUND OF THE INVENTION

Conventionally, Bluetooth technique is a low-cost, low-power and short-distance wireless communication technique, which can be extensively applied to any kind of personal mobile communication apparatus. By using the wireless transmitting function of the Bluetooth technique, one can develop a Bluetooth earphone, a portable watch equipped with a cellular phone or a communication device capable of being worn on a finger. These products use a built-in Bluetooth chip to perform wireless transmission, access the Internet or send and receive e-mails. This is quite user-friendly.

There are a number of wireless earphones equipped with a Bluetooth module in the market. These products are usually used with Bluetooth cellular phones. Reference is made to FIG. 1, which is a block diagram of a conventional communication apparatus comprising a cellular phone and wireless earphones. Therein, the Bluetooth modules 73, 81 of the cellular phone 70 and the wireless earphones 80 can communicate with each other in a wireless full-duplex manner. Hence, a cellular phone 70 can receive sound signals via the mobile communication control module 71 and then send sound signals to the wireless earphones 80 via the Bluetooth module 73. After being received by the Bluetooth module 81 of the wireless earphones 80, the sound signals can be heard by a user via the earphone module 83 disposed inside the wireless earphones 80 (a speaker is used to output the sound signals). The user can also use the earphone module 83 to reply (a microphone is used to receive the user's voice).

However, current cellular phones are often capable of playing multimedia files. As shown in FIG. 1, the cellular phone 70 has a music playing module 75 built inside. Hence, a user can use the cellular phone 70 to listen to music via a wired earphone or a speaker disposed in the cellular phone 70.

From the user's perspective, a friendlier interface for the cellular phone 70 for outputting sounds is desirable. Since wired earphones can easily be ripped off when a user is listening to music, wired earphones are very inconvenient. Furthermore, if a speaker is used to output the music, the user cannot enjoy high-quality music because of environmental interferences.

Using wireless earphones to listen to music is therefore a better solution. However, the bandwidth employed in present Bluetooth technique is about 1 Mbps, while the necessary bandwidth for transmitting sound signals in a music format is at least 30 Mbps. Hence, a direct combination of conventional Bluetooth cellular phones with wireless earphones to transmit sound signals cannot be achieved.

Accordingly, as discussed above, the prior art still has some drawbacks that could be improved upon. The present invention aims to resolve the drawbacks in the prior art.

### SUMMARY OF THE INVENTION

An objective of the present invention is to provide a communication apparatus for playing sound signals that can transmit played music from a cellular phone to wireless earphone data by employing signals matching the Bluetooth protocol.

Another objective of the present invention is to provide a communication apparatus for playing sound signals that can output stereo music.

For reaching the objective above, the present invention provides a communication apparatus for playing sound signals, comprising a cellular phone and wireless earphones. The cellular phone comprises a music playing module used to output music data, a first sound processing module used to encode the music data and output encoded music data, a first Bluetooth module used to transmit the encoded music data and a mobile communication control module used to transmit/receive radio signals and control the music playing module. The wireless earphones comprises a second Bluetooth module used to receive the encoded music data from the first Bluetooth module, a second sound processing module used to decode the encoded music data, and an output unit used to output the music data decoded by the second sound processing module.

For reaching the objective above, the present invention also provides a communication method for playing sound signals. The method provides a cellular phone equipped with a first Bluetooth module, encodes music data played by the cellular phone according to a Bluetooth protocol to form encoded music data and transmits the encoded music data via the first Bluetooth module of the cellular phone, receives the encoded music data via wireless earphones equipped with a second Bluetooth module, decodes the encoded music data, and outputs the decoded music data via the wireless earphones.

For reaching the objective above, the present invention further provides a cellular phone for transmitting sound signals. The cellular phone comprises a music playing module used to output music data, a first sound processing module used to encode the music data and output encoded music data, a first Bluetooth module used to transmit the encoded music data, and a mobile communication control module used to transmit/receive radio signals and control the music playing module.

For reaching the objectives above, the present invention additionally provides wireless earphones for receiving sound signals. The wireless earphones comprise a second Bluetooth module used to receive encoded music data from a first Bluetooth module, a second sound processing module used to decode the encoded music data, an output unit used to output the encoded music data decoded by the second sound processing module, and a microprocessor having a digital signal processor used to determine a format of the encoded music data and then send the encoded music data to the second sound processing module directly or to the output unit after processing the encoded music data according to a determined result.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional communication apparatus consisting of a cellular phone and a wireless earphone;

FIG. 2 is a block diagram of a communication apparatus for playing sound signals in accordance with the present invention;

FIG. 3 is a block diagram of a music playing module in accordance with the present invention; and

FIG. 4 is a flowchart of a communication method for playing sound signals in accordance with the present invention.

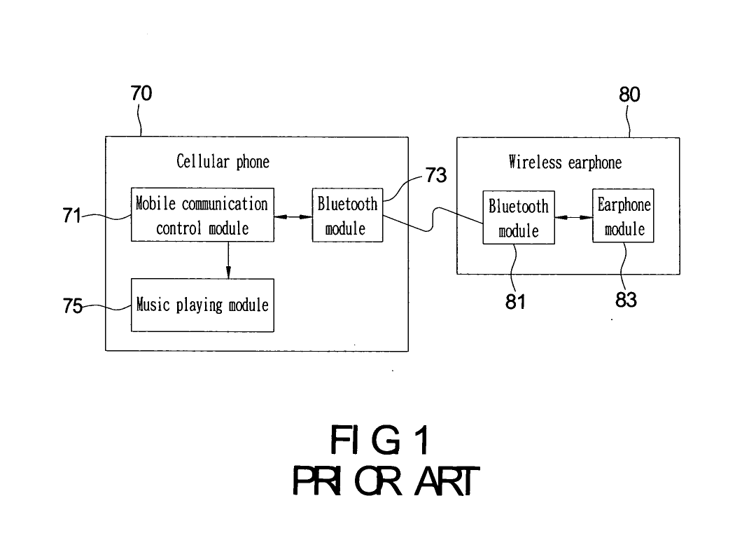

### DETAILED DESCRIPTION

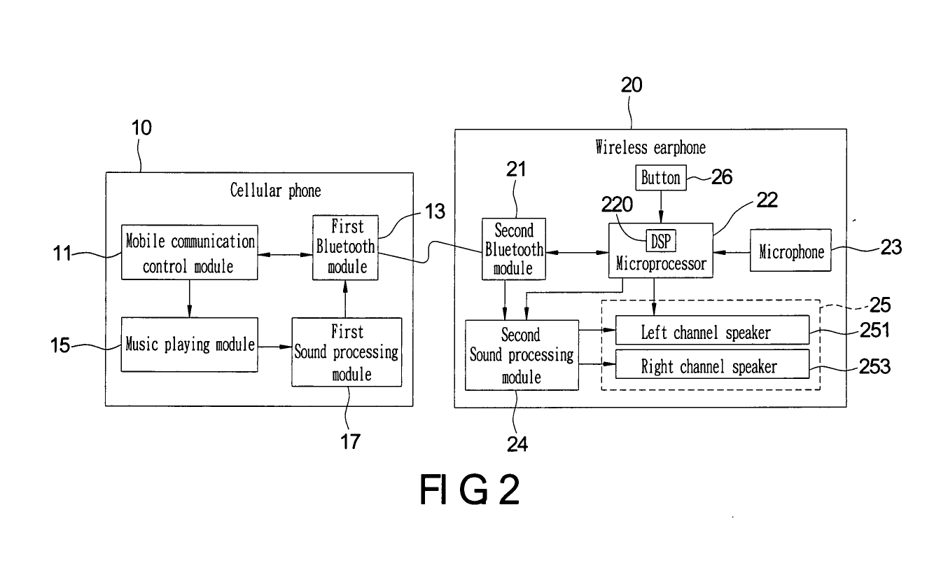

Reference is made to FIG. 2, which is a block diagram of a communication apparatus for playing sound signals in accordance with the present invention. The communication apparatus of the present invention includes a cellular phone 10 and wireless earphones 20.

The cellular phone 10 includes a mobile communication control module 11, a first Bluetooth module 13, a music playing module 15, and a first sound processing module 17. The mobile communication control module 11 is used to transmit/receive radio signals and to control the music playing module 15, as well as receive a control signal transmitted by the wireless earphones 20. The first Bluetooth module 13 is used to transmit received sound signals to the wireless earphones 20 in a wireless manner. The music playing module 15 is able to output played music data to the first sound processing module 17, which will encode the music data to fit the Bluetooth protocol. In this embodiment, the first Bluetooth module 13 can also be used to transmit the encoded music data from the first sound processing module 17 to the wireless earphones 20 in a wireless manner.

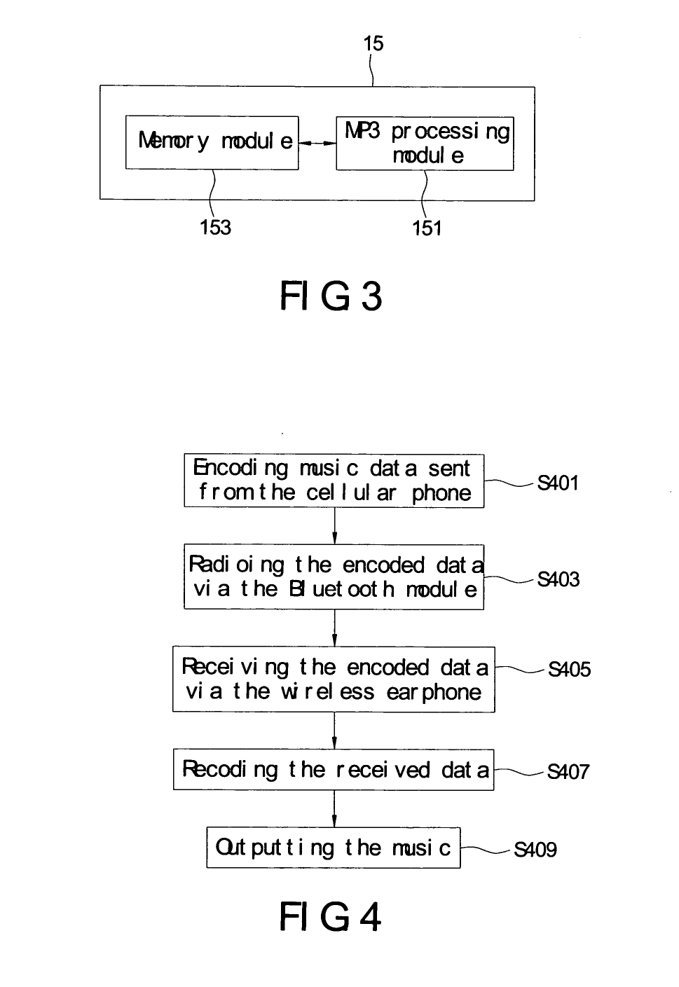

The music playing module 15 can be a radio circuit or, as shown in FIG. 3, comprise a MP3 processing module 151 and a memory module 153. The memory module 153 can be used to store MP3 music files while the MP3 processing module 151 can be used to play them.

Alternatively, the wireless earphones 20 include a second Bluetooth module 21, a microprocessor 22, a digital signal processor 220, a microphone 23, a second sound processing module 24, a plurality of button keys 26, and an output unit 25. The second Bluetooth module 21 can receive the sound signals or encoded music data from the first Bluetooth module 13 of the cellular phone 10. The microprocessor 22 can determine if the received data format belongs to the sound signals or encoded music data from the second Bluetooth module 21. If the sound signals are received, after processing by the microprocessor 22, the sound signals will be sent to the left channel speaker 251 or the right channel speaker 253 of the output unit 25. At this time, a user can also speak via the microphone 23 to respond, and the voice from the user will be processed by the microprocessor 22 and then sent back to the cellular phone 10 via the second Bluetooth module 21. If encoded music data is received, the microprocessor 22 will send the encoded music data to the second sound processing module 24 for decoding and recovering the original music data and then send the recovered data to the left and right channel speakers 251, 253 of the output unit 25 for outputting stereo music.

In the embodiment, the output unit 25 includes the left and right channel speakers 251, 253, which correspond to the two sound channels of the music data with stereo sound. Furthermore, for outputting the sound signals with a single sound channel from the cellular phone 10, only one of the speakers of the output unit 25 is needed. Moreover, either the left or the right channel speaker 251, 253 can be independently disposed in a second housing via a detachable extended line. Hence, when the user only uses the earphone 20 to hear the sound signals from the cellular phone 10, he or she can detach the independently disposed speaker to reduce the load.

The wireless earphones 20 further include a plurality of button keys 26 which are set to encode music data or voice signals such as encoded music data play order, stop or continuous command. A control signal is generated by the button keys 26 in accordance with the above-mentioned various commands. The control signal is sent to the digital signal processor 220 of the microprocessor 22. Next, the digital signal processor 220 judges whether the control signal is an encoded music signal or a voice signal. The control signal transmits to the first Bluetooth module 13 via the second Bluetooth module 21. The first Bluetooth module 13 receives the control signal for transmission to the mobile communication control module 11 for judging the type of control signal. If the control signal is a music signal controlling signal, then the music data comprises played order control signal such as forward, rewind, stop or skip. Otherwise, if the control signal is a voice controlling signal, then voice controlling comprises end controlling or hands-free controlling.

Reference is made to FIG. 4, which is a flowchart of a communication method for playing sound signals in accordance with the present invention. In order to send the played music data from the cellular phone 10 to the wireless earphones 10 in a wireless manner, the music data from the cellular phone 10 is encoded (S401). The music data is output from the music playing module 15 and encoded by the first sound processing module 17. The encoded music data is transmitted via the first Bluetooth module 13 of the cellular phone 10 (S403). The wireless earphones 200 can then receive the encoded music data via the second Bluetooth module 21 (S405). The second sound processing module 24 of the wireless earphones 20 will decode the encoded music data to recover the original music data (S407). Finally, the wireless earphones 20 will output stereo music via the left and right channel speakers 251, 253 of the output unit 25 (S409).

Consequently, the communication apparatus for playing sound signals of the present invention enables the cellular phone 10 to transmit sound signals via the Bluetooth module 13. The sound signals are encoded by the sound processing module 17 to fit the Bluetooth protocol before transmission. When the encoded data is received by the wireless phone 20, the data is first decoded by the sound processing module 24 and then sent to the output unit 25. The output unit 25 employs the left and right channel speakers 251, 253 to allow the wireless earphones 20 to provide music in stereo.

Therefore, the communication apparatus for playing sound signals of the present invention has the following features:
(1) Music data can be played via a cellular phone and received by a wireless earphone; and
(2) The wireless earphones employ two sound channels to provide stereo music.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A communication apparatus for playing sound signals, comprising a cellular phone and a wireless earphones, the cellular phone comprising:
a music playing module used to output music data;
a first sound processing module used to encode the music data and output encoded music data;
a first Bluetooth module used to transmit the encoded music data; and
a mobile communication control module used to transmit/receive radio signals and control the music playing module; and the wireless earphones comprising:
a second Bluetooth module used to receive the encoded music data from the first Bluetooth module;
a second sound processing module used to decode the encoded music data; and
an output unit used to output digital data decoded by the second sound processing module.

2. The apparatus as claimed in the claim 1, wherein the music playing module is a radio circuit.

3. The apparatus as claimed in the claim 1, wherein the music playing module comprises:
a memory used to store a music file; and
an MP3 processing module used to play the music file.

4. The apparatus as claimed in the claim 1, wherein the output unit comprises a left channel speaker and a right channel speaker.

5. The apparatus as claimed in the claim 4, wherein the left or the right channel speaker is independently disposed in a second housing via an extended line.

6. The apparatus as claimed in the claim 5, wherein the extended line is detachable.

7. A communication method for playing sound signals, comprising:
providing a cellular phone equipped with a first Bluetooth module;
encoding music data played by the cellular phone according to a Bluetooth protocol to form encoded music data and transmitting the encoded music data via the first Bluetooth module of the cellular phone;
receiving the encoded music data via wireless earphones equipped with a second Bluetooth module and decoding the encoded music data; and
outputting the decoded music data via the wireless earphones.

8. The method as claimed in the claim 7, wherein the music data is in an MP3 format.

9. The method as claimed in the claim 7, wherein the music data is a signal received by a radio.

10. The method as claimed in the claim 7, wherein the wireless earphones output the decoded music data via two sound channels.

11. A cellular phone for transmitting sound signals, comprising:
a music playing module used to output music data;
a first sound processing module used to encode the music data and output encoded music data;
a first Bluetooth module used to transmit the encoded music data; and
a mobile communication control module used to transmit/receive radio signals and control the music playing module.

12. The cellular phone as claimed in the claim 11, wherein the music playing module is a radio circuit.

13. The cellular phone as claimed in the claim 11, wherein the music playing module comprises:
a memory used to store a music file; and
an MP3 processing module used to play the music file.

14. A wireless earphones for receiving sound signals, comprising:
a second Bluetooth module used to receive encoded music data;
a second sound processing module used to decode the encoded music data;
an output unit used to output digital data decoded by the sound processing module; and
a microprocessor used to determine a format of the encoded music data and then send the encoded music data to the second sound processing module directly or to the output unit after processing the encoded music data according to a determined result.

15. The wireless earphones as claimed in the claim 14, wherein the output unit comprises a left channel speaker and a right channel speaker.

16. The wireless earphones as claimed in the claim 15, wherein the left or right channel speaker is independently disposed in a second housing via an extended line.

17. The wireless earphones as claimed in the claim 16, wherein the extended line is detachable.

18. The wireless earphones as claimed in the claim 14, wherein the microprocessor includes a digital signal processor.

19. The wireless earphones as claimed in the claim 14, further comprising a microphone, the microprocessor outputting voice signals received from the microphone via the second Bluetooth module.

20. The wireless earphones as claimed in the claim 14, further comprising a microphone for outputting various control signals to play/control the encoded music data or voice signals.
